(19) United States
(12) Patent Application Publication
(10) Pub. No.: US 2003/0041702 A1
(43) Pub. Date: Mar. 6, 2003

(54) Automobile brake cable positioning pliers

(76) Inventor: Hsin Fa Kang, Tainan City (TW)

Correspondence Address: Kang Hsin Fa, P.O. Box 90, Tainan City, 704, TW

(21) Appl. No.: 09/942,693

(22) Filed: Aug. 31, 2001

(51) Int. Cl. B25B 7/12

(52) U.S. Cl. 81/302

(57) ABSTRACT

An automobile brake cable-positioning pliers includes two symmetrical pinch members, a locking member, and a torque spring. The two pinch members have extensions formed to extend up form upper ends and having sloped ends and an opening. The locking member is pivotally connected to one of the two pinch members, and the other pinch member has at least one engage notch to face a function end of the locking member, then the upper ends of the pliers open to a preset width, and the pliers quickly and smoothly insert in the brake to pinch a wire rope of a brake shoe, and then one end of the locking member is pressed to engage the engage notch to open the upper ends of the pliers to push open the spring to take off or insert the wire rope in the brake shoe.

### BACKGROUND OF THE INVENTION

This invention relates to an automobile brake cable-positioning pliers, particularly to one especially usable for assembling or disassembling brake shoes. The feature of the invention has two symmetrical pinch portions, and two extensions of the two pinch portions having respectively a sloped end surface and an opening, and a plurality of notches formed in an intermediate section of one of the pinch portion to engage with a function end of a locking member. Thus the brake cable positioning pliers quickly inserts in the brake shoe to hook the brake cable connected to the brake shoe, with the upper ends of the pliers opens and pushes off springs keeping the brake cable in place so the brake cable may be loosened and taken off. In addition, the pinch portions have a plurality of notches to permit the pliers may be opened to various different distances to suit to various specifications of different car types.

In general, automobiles have a brake system of either a drum brake or a disc brake, and the drum brake system has a brake drum fixed on an axle of the wheels and rotating together with the wheel. The brake drum has two symmetrical crescent shoes 6, as shown in FIG. 7, and a brake lining attached on each brake shoe to friction with an inner wall of the brake drum when the brake is operated between the lining and the inner wall of the brake drum to stop the wheel with high friction force.

Another handle brake is used to prevent an automobile from sliding to move when an automobile is parked. Or it prevents an automobile from retreating backward during running up a slope. The handle brake includes a cable 7 connected pivotally to a swing arm 60 of a brake shoe 6, with the swing arm 60 provided outside of the brake shoe as shown in FIG. 6 or inside the swing arm of the brake shoe as shown in FIGS. 7 and 8. Then the handle brake is pulled to draw the cable 7 so as to pull the swing arm 60 to let brake shoe move toward the inner wall of the brake drum to stop the wheel. After the linings wears to a certain degree, the brake shoe 6 with the lining has to be replaced with a new one, in order to keep safety in driving an automobile.

At present, in changing a brake shoe 6 a special brake pliers is used for separating the wire rope from the swing arm 60 of the brake shoe 6. The special brake pliers includes two symmetrical pinch sections and pivotally connected at intermediate portions for opening or closing properly upper ends of the two pinching sections. In separating the cable 7 from the swing arm of the brake shoe, two contact sections formed in the upper ends of the pinch sections pinch two sides of a hook groove 61 of the swing arm 60, but a recover spring 8 with considerable resilience is fitted at one end of the swing arm 60, so a worker has to continue to hold the grip of the pliers and keep the upper ends in an open condition, and then separates one end of the recover spring 8 from the cable 7 to let the cable move in the hook groove 61 (or to take off the cable 7). However, in assembling or disassembling the cable 7, a worker has to continue to pinch inward the pliers to keep the upper end open, or the recover spring 8 recovers its resilience to close the upper ends of the pliers. So on the other hand the worker has to grip inward the pliers, he has to manage to let the end of the cable fit in (or taken away) the hook groove 61 of the swing arm 6, requiring an other worker to give a hand in the work. So this conventional special cable pliers is not convenient to use.

### SUMMARY OF THE INVENTION

This invention has been devised to offer an automobile brake cable-positioning pliers for assembling or disassembling a brake shoe.

The feature of the invention is one or more engage notches formed in one of two pinch members, a locking member pivotally connected to an intermediate section of one of the two pinch members and having a torque spring to keep the locking member always pushed outward and a function end to engage one of the engage notch, a torque spring extending around a pivot of the two pinch members and having two feet extending down along the two pinch members and two grips connected to the pinch sections so that the two grips are normally pushed open by the torque of the torque spring and the pliers is always kept closed at the upper ends when not used.

### BRIEF DESCRIPTION OF DRAWINGS

This invention will be better understood by referring to the accompanying drawings, wherein:

FIG. 1 is a perspective view of an automobile brake cable-positioning pliers in the present invention;

FIG. 2 is a front view of the automobile brake cable-positioning pliers in an unused condition in the present invention;

FIG. 3 is a front view of the automobile brake cable-positioning pliers with two grips pressed inward in the present invention;

FIG. 4 is a front view of the automobile brake cable-positioning pliers with two grips pressed inward and with a locking member inserted in a locking notch to let the upper ends opened at a preset position in the present invention;

FIG. 5 is a front view of the upper ends the brake cable-positioning pliers opened to a maximum space in the present invention;

FIG. 6 is a perspective view of the automobile brake cable-positioning pliers used to pinching a swing arm of a brake shoe in a hand brake in the present invention;

FIG. 7 is a front view of the brake cable positioning pliers catching a wire rope in hand brake in the present invention;

FIG. 8 is a front view of the brake cable-positioning pliers plying open the spring on the wire rope of a hand brake in the present invention; and,

FIG. 9 is a rear view of the automobile brake cable-positioning pliers in the present invention.

### DETAILED DESCRIPTION OF THE PREFERRED EMBODIMENT

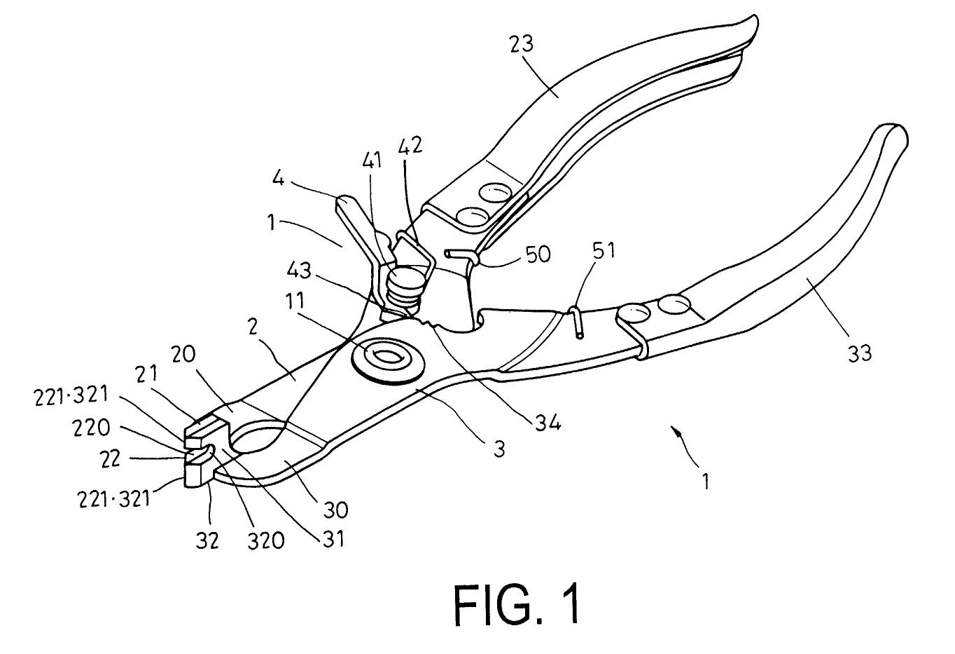

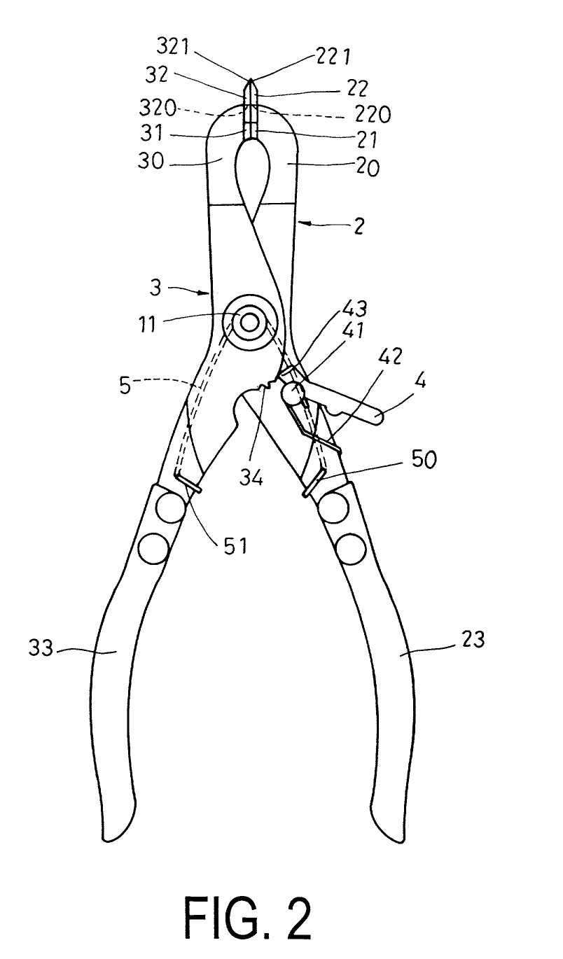

A preferred embodiment of an automobile brake cable positioning pliers in the present invention, as shown in FIGS. 1, 2 and 9, includes two symmetrical pinch members 2, 3, two symmetrical pinch sections 20, 30 formed to extend up from upper ends of the two pinch members 20, 30, so the two pinch members 2, and the two pinch sections 20, 30 are respectively formed integral, and pivotally connected with each other with a pivot 11 located in intermediate sections of the two pinch members 2, 3. The two pinch sections 20, 30 respectively have an outer pinch blocks 21, 31 formed integral on a vertical end surface, and the outer pinch blocks 21, 31 have upper extensions 22, 32 to protrude up from an upper end of each pinch sections 20, 30. Then the two outer pinch blocks 21, 31 have enough strength and push force, keeping the shape of the brake cable-positioning pliers from disfiguring so as to enhance work effect. Further, the pinch blocks 21, 31 have an opening 220, 320 in the extensions 22, 32 and sloped ends 221, 321. Further, two grips 23, 33 are connected with lower ends of the two pinch members 2, 3 for convenience of holding and pressing inward or releasing the pliers in the invention. One of the two pinch members 3 is formed with one or more engage notches 34 in an outer edge of the intermediate section.

The brake cable-positioning pliers 1 further include a locking member 4 pivotally connected with one pinch member 2 at an intermediate section with a rivet 41 between the pivot 11 and an upper end of one grip 23. The rivet 41 is provided near one end of the locking member 4, connecting the locking member 4 with the pinch member 2, and a torque spring 42 is deposited between the pivot 41 and a right side edge of the pinch member 2 to always biasly pushing the locking member 4 outward. Further, the locking member 4 has a function triangle end 43 near a rivet 41 pivotally connecting the locking member 4 to the pinch member 2, with the function triangle 43 facing the engage notches 34 of the left pinch member 3.

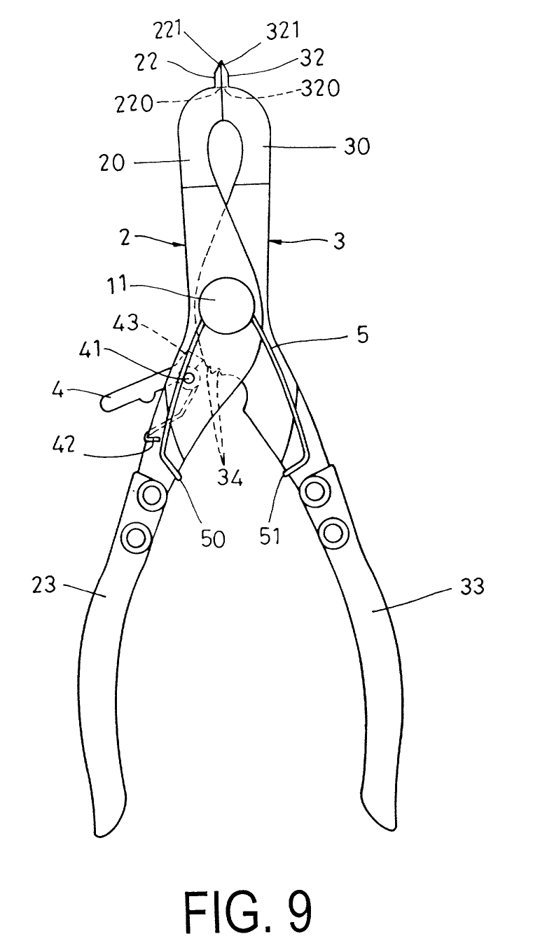

Further, another torque spring 5 is provided on a rear surface of the pivot 11, as shown in FIG. 9, having two side feet 50, 51 respectively extending down along the two pinch members 2, 3 to the grips 22, 32 in corresponding relation so as to elastically push the two grips 22, 23 always outward to close the pliers 1 normally.

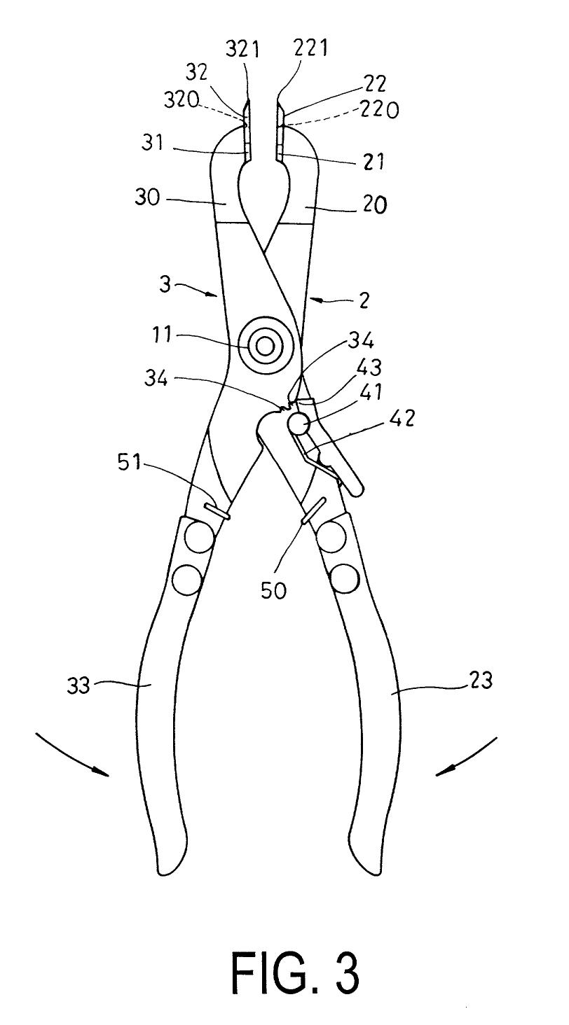

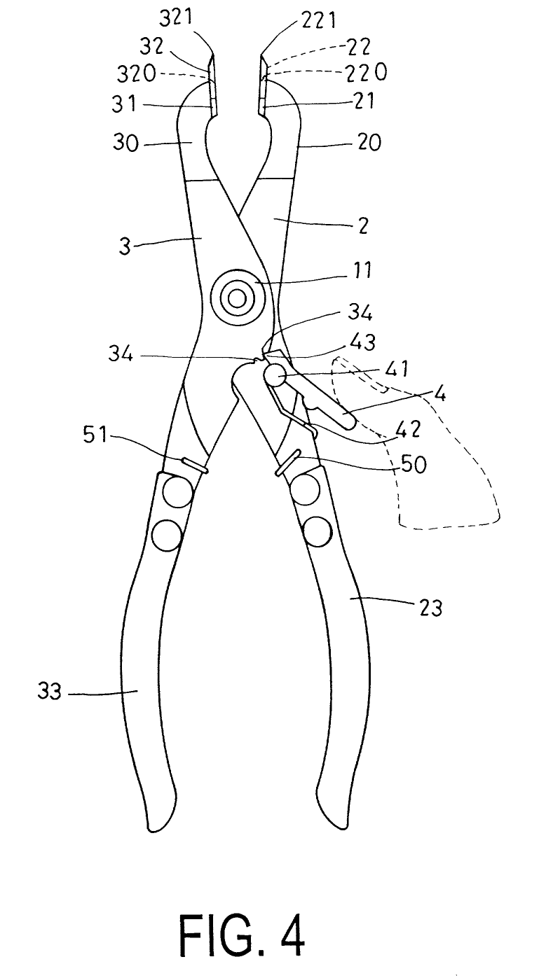

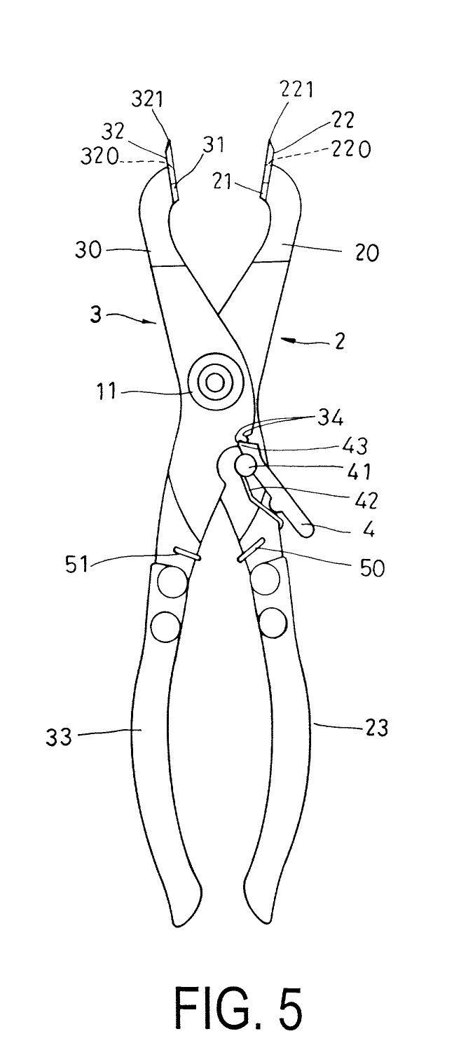

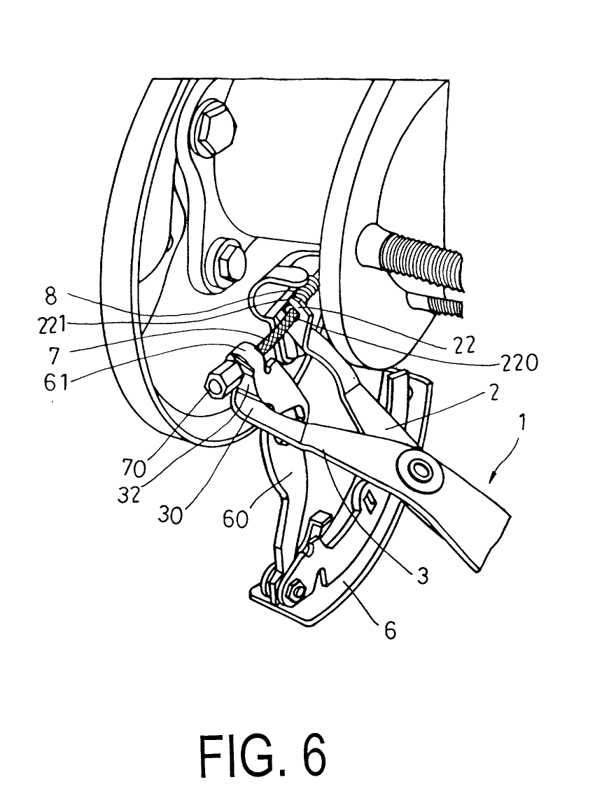

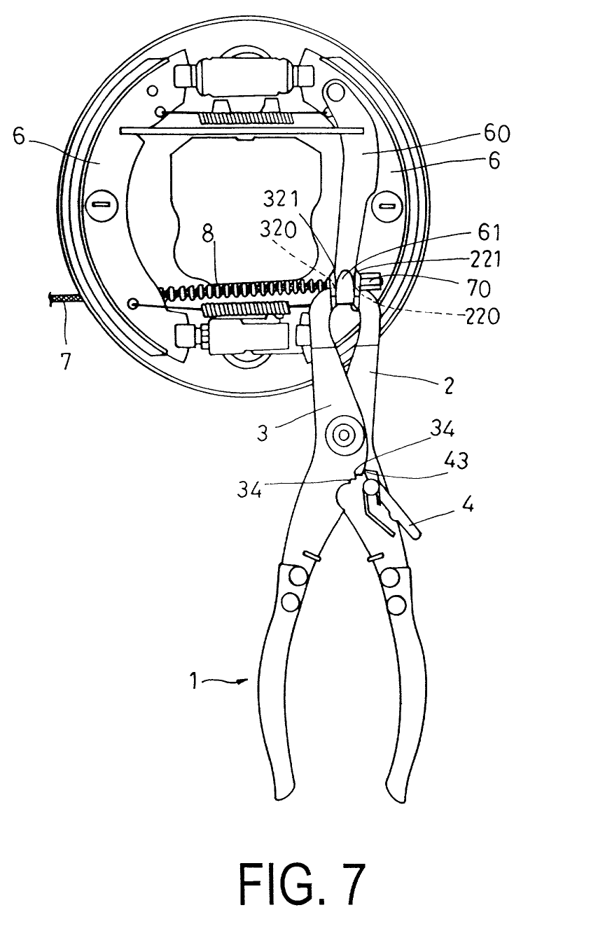

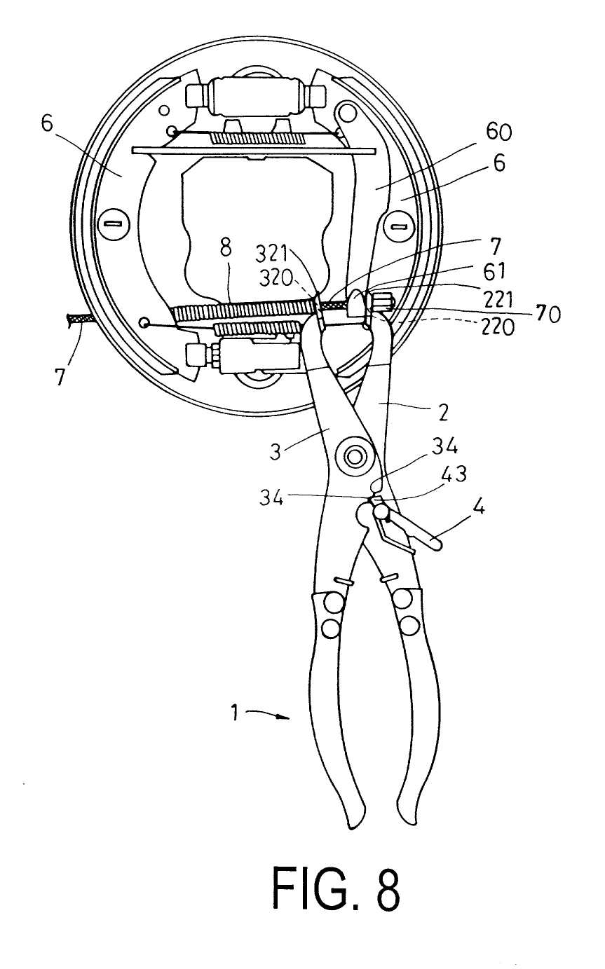

In using the pliers 1, referring to FIGS. 3-8, for taking off a brake shoe 6, firstly hold and press inward two grips 22, 23 of the pliers 1 (referring to FIG. 3), moving the two pinch sections 20, 30 toward the hook groove 61 where the wire rope 7 is hooked with the swing arm 60, and then letting the sloped ends 221, 321 of the extensions 22, 32 respectively inserted in two sides of the hook groove 70 (as shown in FIG. 7, one side of the hook groove 61 is stopped by a fixer 70 of the wire rope 7, and the other side of the hook groove 61 is pushed firmly by the spring 8), and at the same time the wire rope 7 falls in the openings 220, 320 of the extensions 22, 32. After that, press the two grips 23, 33 inward again, letting the upper ends of the pliers 1 easily extend on the brake shoe 6 or in the swing arm 60 (owing to different car types, the swing arm 60 may be located outside or inside the brake shoe 6). As the two grips 23, 33 of the pliers 1 gradually moves nearer to each other, and synchronously the function ends 43 of the locking member 4 may slide along the curved edge of the pinch member 3 (also referring to FIG. 3), letting the extensions gradually move inward to press the spring 42 of the pivot rivet 41 and the function ends 43 of the locking member 4 engage the engage notch 34 of the pinch member 3, keeping the upper ends of the pliers open (as shown in FIGS. 4 and 5). In addition, the locking member 4 is pushed elastically by the spring 42 recovering its resilience to be locked in place, so that the pliers 1 has the two contact sections 21, 31 opened at a preset distance owing to the torque of the torque spring 5 of the two grips 22, 32 (referring to FIGS. 4, 5, 6 and 8). In this way, the springs 8 on the sidewall of the hook groove 61 of the swing arm 60 may be pushed open, as shown in FIGS. 6 and 8, and the wire rope 7 can be taken off (or inserted in) the hook groove 61 of the swing arm 60, facilitating assembling and disassembling of the brake shoe 6. No matter how different are the specifications of car types, the spring 8 of the wire rope 7 can be pushed open comparatively wide for easily taking out the wire rope (also compare FIGS. 5 and 8), by continuing to push manually the end of the locking member 4 (as shown in FIG. 4.) letting the function end 43 disengage from the upper engage notch 34, and at the same time hold the grips 23, 32 to let the locking member 4 slide and engage the lower engage notch 34. permitting the upper ends of the pliers 1 to open to the maximum width (as shown in FIG. 5), facilitating taking off or inserting the wire rope 7.

After removing and displacing the brake shoe 6 with a new one (it means after the wire rope 7 is taken off or inserted in the hook groove 61 of the swing arm 61), the pliers 1 is easily collapsed for storing by manually pressing the outer end of the locking member 4, separating the function ends 43 disengaging from the upper or the lower engage notch 34 (referring to FIG. 4) with the rivet 41 as a pivot, and the spring 5 pushes open the two grips 22, 32 with the pivot 11, letting the upper ends of the pliers 1 completely closed (as shown in FIG. 9).

The automobile brake cable positioning pliers in the invention has the following advantages, as can be understood from the above description.

1. Assembling and disassembling of the brake shoe is easily done by the provision of function ends of the locking sections and the upper and the lower engage notch of the pinch member for the upper ends of the pliers opened to a preset width and the spring of the wire rope possible to be pushed open to a preset distance.

2. The locking member can be handled with only one hand, saving manual force, facilitating handling easy, and using with convenience.

3. The two extensions and the two-sloped ends and the openings in the extensions can quickly and smoothly insert in the two sides of the hook groove of the swing arm of the brake shoe, and lock the wire rope.

4. The pliers is not only opened to a preset width, but also easily closed.

5. The upper ends of the pliers can be opened to various widths to apply to various types of automobiles, by providing one or more engage notches on one of the pinch members to engage the function end of the locking member. For instance, when the pliers is opened to the largest width, operating work for the wire rope is comparatively easy, and if the wire rope is fixed to leave a small space at the end (generally some cars made in Japan), the pliers can only be opened half open, with the first engage notch 34 engaging the function end of the locking member as shown in FIG. 4. So a worker does not need to continue to hold inward the grips, saving manual force and convenient to operate the pliers.

While the preferred embodiment of the invention has been described above, it will be recognized and understood that various modifications may be made therein and the appended claims are intended to cover all such modifications that may fall within the spirit and scope of the invention.

I claim:

1. An automobile brake cable positioning pliers comprising two symmetrical pinch members pivotally connected with a pivot to open or close, upper ends of said pinch member formed integral with two pinch sections for pinching a brake cable stably between them;
characterized by one of said two pinch member having one or more engage notches formed in an intermediate section;
a locking member pivotally connected to another of said two pinch members at intermediate locations, having a spring to keep said locking member always elastically pushed outward, and an upper function end facing said engage notches;
a torque spring deposited on two grips connected to lower ends of said two pinch sections, keeping with its torque said two grips normally stretch outward so that said brake cable positioning pliers elastically closed at its upper ends when not used; and,
a user holding and gradually pressing inward said grips, letting said function end of said locking member pushed by the end of the other pinch section, said outer side of said function end gradually pressing said spring at said pivot until said function end completely engage one of the engage notches, said torque spring at the pivot of the locking member recovering its resilience to let the other end pushed outward, said two grips at the same time elastically pushed outward by resilience of said torque spring so that the pinch sections are positioned at a preset width.

2. The automobile brake cable positioning pliers as claimed in claim 1, wherein said two pinch members consists of said two pinch sections formed in upper portions, an extension respectively formed to extend up from an upper end of each pinch section, said extensions having respectively an opening and a sloped upper end; said sloped ends firstly inserting quickly and smoothly in an end of said spring of said wire rope of said brake cable, said wire rope at the same time falling in said openings, said grips held pressed inward again letting the function end of said locking member engage in one of said engage notches so that said pliers opens at a preset width and push open the spring and facilitate assembling and disassembling the wire rope for taking off or depositing the brake shoe.

3. The automobile brake cable positioning pliers as claimed in claim 1, wherein said pinch members has one or more engage notches to permit said pliers have many open width for applying it to various types of automobiles.

4. The automobile brake cable positioning pliers as claimed in claim 1, wherein said torque spring is located at rear sides of said two pinch sections, extending around said pivot and having two feet respectively extending down along said two grips and hooked on said two grips.
